(19) United States
(12) Patent Application Publication
(10) Pub. No.: US 2021/0339994 A1
(43) Pub. Date: Nov. 4, 2021

(54) INDUSTRIAL TRUCK

(71) Applicant: Jungheinrich Aktiengesellschaft, Hamburg (DE)

(72) Inventors: Carsten Schöttke, Moosburg (DE); Hubert Bibernell, Landshut (DE); Michael Schönauer, Moosburg (DE)

(21) Appl. No.: 17/246,894

(22) Filed: May 3, 2021

(30) Foreign Application Priority Data
May 4, 2020 (DE) 10 2020 205 606.4

(51) Int. Cl. B66F 9/075; B66F 17/00

(52) U.S. Cl. CPC B66F 9/07559; B66F 9/07568; B66F 9/07586; B66F 17/003

(57) ABSTRACT

An industrial truck comprises a vehicle body, a lifting frame, at least one load wheel, at least one further wheel, at least one actuator, at least one detection unit configured to detect a current operating parameter of the industrial truck, and a control unit. The control unit is configured to define a target state of the industrial truck, to receive data from the detection unit to determine an actual state of the industrial truck based on the detected operating parameters of the industrial truck, to calculate the effects of possible adjustments of the relative position of the load wheel with respect to the vehicle body on the actual state of the industrial truck, and to instruct the at least one actuator to adjust the relative position of the load wheel with respect to the vehicle body to approximate the actual state of the industrial truck to the target state.

The present invention relates to improvements in industrial trucks, in particular in narrow aisle forklifts.

A typical problem that occurs during the operation of industrial trucks and that limits the turnover rates that can be achieved are vibrations of the lifting frame and deformations of the lifting frame during a load change transversely to the direction of travel as well as along the direction of travel. In particular in the case of narrow aisle forklifts that frequently lift goods to very great heights, such vibrations have a particularly disadvantageous effect due to geometric conditions. Other aspects that can play a role in this context are level compensation when the vehicle is stationary and compensation for deformations in the vehicle due to the pushing of loads. As a result, in practice, in order to achieve a maximum travel speed without excessive transverse vibrations of the lifting frame, it is necessary to ensure perfect flatness of the ground on which the industrial truck moves with its wheels. However, this results in high costs and requires regular inspection and maintenance of this ground.

Various systems have been proposed to reduce the vibrations mentioned in the vehicle; for example, it is known from EP 2 814 677 A1 to detect surface properties of the road surface and to counteract the expected kinematic effects on the industrial truck on the basis of this detection using suitable measures. In this case, for example, an active chassis can be considered which influences the wheels of the industrial truck.

A special embodiment of an active chassis of this type is in turn disclosed, for example, in EP 3 309 111 B1, in which it is proposed to rotatably arrange a load wheel of an industrial truck on at least one eccentric disc, which is mounted on the vehicle body about an axis of rotation, which in turn is arranged offset from the axis of rotation of the wheel.

In practice, however, it has been shown that both the aforementioned detection of the driving surface and the storage of load wheels using eccentric discs are not optimal solutions for reducing lifting frame vibrations in industrial trucks.

It is therefore the object of the present invention to provide an industrial truck which has vibration-reducing measures so that it can reach a high speed even on poor driving surfaces without the precision of the tasks to be performed by the industrial truck suffering as a result.

For this purpose, the industrial truck according to the invention comprises a vehicle body, a lifting frame which extends substantially vertically from the vehicle body, at least one load wheel which stands on a ground, at least one further wheel, which also stands on the ground, for example a steered drive wheel which is configured to drive the industrial truck in a steered manner to a movement on the ground, at least one actuator associated with the at least one load wheel, which is configured and arranged to adjust a relative position of the load wheel with respect to the vehicle body, at least one detection unit, which is configured to detect a current operating parameter of the industrial truck and to output corresponding data, and a control unit having an associated memory unit, which control unit is operationally coupled to the at least one actuator and the at least one detection unit and is configured to define a target state of the industrial truck, to receive data from the detection unit, to determine an actual state of the industrial truck based on the detected operating parameters of the industrial truck, to calculate the effects of possible adjustments of the relative position of the load wheel with respect to the vehicle body on the actual state of the industrial truck, and to instruct the at least one actuator in such a way that an approximation of the actual state of the industrial truck to the target state is brought about by adjusting the relative position of the load wheel with respect to the vehicle body.

In addition to the example mentioned, in which the at least one further wheel is designed as a steered drive wheel, other combinations of drive and steering are also conceivable, for example the at least one load wheel could be driven, in particular as part of a driven load axle, so that the further wheel then could be a steered wheel without a drive.

In this case, the detection unit can in particular be configured to detect at least one of an inclination of the vehicle body relative to the ground and/or the horizontal, and an acceleration and/or a speed and/or an inclination of at least one component of the industrial truck and/or a load carried by the industrial truck (10) with respect to the ground and/or at least one other component of the industrial truck, wherein the acceleration to be detected can in particular be directed transversely to a direction of travel of the industrial truck.

According to the invention, operating parameters of the industrial truck itself are first used, for example by using an inclination sensor to determine the level of the vehicle body absolutely relative to the horizontal or based on a previously defined level, for example on ground inclined at a predefined angle relative to the horizontal. In a case of this type, the control of the actuator can be used to align the vehicle body and thus the lifting frame with respect to the horizontal.

In another example, a plurality of sensors can be used as detection units, for example a first sensor on the load wheel axle discussed in more detail below and a second sensor on a rear part of the vehicle body that is decoupled from this load wheel axle. In that the position of the two sensors relative to one another is now determined, a required actuator reaction can be calculated by the control unit, by means of which the two vehicle components discussed can be brought into an optimal alignment with one another.

In a further variant, a first sensor could also be associated with a first movably arranged load wheel, a second sensor could also be associated with a second movably arranged load wheel and a third sensor with the vehicle body decoupled from the wheels. This variant is suitable for embodiments of the industrial truck according to the invention in which a rigid load wheel axle is dispensed with.

Furthermore, the current operating parameter can include a state of movement, such as a speed or an acceleration of a vehicle component or a position of the vehicle. As an example for this case, an acceleration sensor can be considered which detects an acceleration vector substantially transverse to the direction of travel of the industrial truck, for example on the lifting frame or on a raised load part. From this, the control unit can then determine an actuator reaction which counteracts this acceleration vector or at least minimises its magnitude.

In this context, a speed vector and furthermore a relative position specification could be determined by continuously integrating such acceleration vectors from a specific starting state. The two examples just mentioned can also be used in combination with one another or complementary to one another in a single industrial truck according to the invention.

Of course, at least one further detection unit can also be provided on the industrial truck, which detection unit is configured to detect at least one property of the surroundings of the industrial truck and to output corresponding data to the control unit. The detection of the surroundings includes in this case detection of the driving surface, but is not limited to this and other waypoints or objects in the surroundings of the vehicle can also be detected. Possible embodiments for such detection units include laser sensors, ultrasonic sensors and radar sensors which, for example, scan regions in front of or next to the at least one load wheel. In this way, projections of expected actual states of the industrial truck can be generated so that the actuators of the industrial truck according to the invention can proactively counteract predicted deviations. In particular, 2D and/or 3D detection units can be used.

Furthermore, the or at least one of the detection unit(s) can be associated with the load wheel or at least one of the load wheels, so that the actuator effect may occur directly at the point at which the respective operating parameter and/or the property of the surroundings was detected.

Alternatively or additionally, the or at least one of the detection unit(s) can be associated with the vehicle body, the lifting frame and/or a component of the industrial truck connected to the vehicle body or the lifting frame. Examples of this comprise the acceleration sensors already mentioned above, which can be associated with the lifting frame or a component that can be moved thereon, as well as to the vehicle body.

Furthermore, at least one spatial characteristic diagram can be stored in the memory unit of the control unit wherein, in such an embodiment, the control unit is further configured to determine an upcoming change in the actual state of the industrial truck based on current movement parameters of the industrial truck and the at least one diagram. By providing the control unit with a topology or excitation profile map of a region of the ground to be driven on, the actuators of the industrial truck according to the invention can be controlled accordingly in a suitable manner by the control unit. Value vectors from the current position, current speed and current direction of travel, for example, can be used as key parameters for the diagram from which a probable position for a later point in time can be derived together with a required actuator position at this point in time to level the vehicle or to counteract a vibration.

Furthermore, the industrial truck according to the invention can comprise at least one receiving device which is configured to receive data from an external means which data represent information about the position and/or the surroundings of the industrial truck. In a manner similar to the diagrams just described, the data transmitted by the external means can also contain local topology or excitation information. In addition to the transmission of corresponding data using known wireless data transmission standards, barcodes or QR codes having local topology information positioned along defined lanes or at suitable points in a freely drivable region can also be considered. In a similar way, transmitters, for example RFID tags, can be placed along the lane or at suitable positions, which can transmit topology information to suitable receiving devices on the industrial truck according to the invention.

As already briefly mentioned above, at least one load wheel axle can be provided in the industrial truck according to the invention, which axle carries two load wheels lying opposite one another. Such configurations of load wheels are used, for example, in industrial trucks which have only one driven and steered drive wheel spaced apart from the load wheel axle, or combinations in which the load axle is driven and the other wheel is only steered. In this case, the at least one load wheel axle can be suspended on the vehicle body such that it can pivot about a pivoting plane running horizontally perpendicular to the load wheel axle or by means of a resilient element, and the at least one actuator can be configured to cause the load wheel axle to pivot, whereby, optionally, a damping element can be further arranged for damping the pivoting movement between the pivot axle or the resilient element and the vehicle body.

In this case, the pivot axle can be arranged either centrally in the vehicle width direction of the industrial truck or laterally offset. Likewise, in embodiments with a single damping element and a single actuator, these can be provided on the opposite or the same side of the pivot axle. Possible actuators include hydraulic cylinders, lifting magnets, threaded spindles, linear motors, toothed racks, piezo elements, etc., a typical stroke in the vertical direction being approximately ±3 mm.

A mechanical spring or a hydraulic damper could further be used as a damping element and in particular also for load compensation, wherein, in the case of a spring, this can be designed in such a way that a pressure is always present in the corresponding actuator. In the event that a double-acting cylinder is provided as the actuator, the damping element can easily be dispensed with. In a variant, two double-acting cylinders could also be arranged symmetrically around the pivot point as respective actuators in order to be able to distribute the forces to be applied and to allow them to be smaller. However, this requires synchronous control of the two cylinders.

In the event that a resilient element is provided for the pivotable suspension of the load wheel axle on the vehicle body, this element can be arranged laterally in the vehicle width direction and thus allow the axle to pivot. In this case, the resilient element can be formed, for example, by a flat spring, a torsion bar, an elastomer spring or the like and the adjustment of the position of the load wheel axle can be made by an actuator of one of the types mentioned above lying opposite the resilient element, whereby the actuator can again be supported by a damping element.

In an alternative embodiment, at least two actuators which are spaced apart from one another and optionally at least one damping element can be provided between the at least one load wheel axle and the vehicle body, which damping element can further be used for base load compensation. In some variants, the means for suspending the load wheel axle just discussed can be dispensed with. In both cases, however, a guide unit for mounting the load wheel axle can be provided in the plane which is spanned by the vertical direction and the extension direction of the load wheel axle. Alternatively, in embodiments with a plurality of actuators, the bearing function can also be taken over by said actuators, with the radial change in length being able to be compensated for by the existing guide play in the actuators when the actuators are set at different heights. Of course, damping elements or elements for load compensation can always be optionally provided in such embodiments as well.

In a structurally different embodiment, the at least one load wheel can also be associated with a frame element that is pivotably articulated on the vehicle body, so that the vehicle body is substantially divided into two. A front end in the form of an articulated link can be considered, with the at least one load-bearing frame part being rotatably connected to the other part of the vehicle body, for example at the height of a frame front wall, the lifting frame being rigidly associated with this other part. The connection point between the two parts of the vehicle body can be designed in a manner similar to that described above in the context of the suspension of the load wheel axle and the corresponding actuators and optionally provided damping elements can also be of the types described above.

As a further alternative, the load wheel or at least one of the load wheels, preferably all of the load wheels, can be arranged individually on the vehicle frame in a linearly displaceable manner in the horizontal direction by at least one actuator, wherein furthermore a damping element can be optionally provided for damping the linear movement. In this context, it should be noted that the movement of the at least one load wheel does not have to run strictly vertically, but can also contain a horizontal component, i.e. it can be inclined.

In this case, for example, the corresponding load wheel and a flange plate can form a unit which is mounted on the base frame so as to be displaceable in the vertical direction by means of a linear guide.

To drive this linear movement, again numerous known types of actuators can be considered, for example hydraulic cylinders, lifting magnets, threaded spindles, linear motors, toothed racks, piezo elements, etc. These can again be complemented by a damping element. In a variant of the embodiment just described, two actuators arranged in parallel can also be provided, as a result of which a linear guide of the corresponding load wheel can be dispensed with.

In order to be able to save installation space in the region of attachment of the at least one load wheel to the vehicle body, the at least one actuator and optionally the at least one damping element can be arranged at least in portions within the contour of the load wheel. In such an embodiment, for example, the wheel bearing can be pulled far outwards and form a connection between a wheel body and an inner ring. This inner ring accordingly forms a basis for the at least one actuator and a linear guide.

Possible embodiments in such variants include hydraulic lifting columns arranged in pairs to restrict the degrees of freedom, or also tangential wedges with linear drive units such as piezo elements, lifting magnets, or lifting cylinders. Since the forces to be absorbed in such embodiments are mainly limited to the vertical wheel load and the torques that occur have only very short lever arms, in addition to the compact design mentioned, an optimal absorption of forces and torques can also be achieved.

In such embodiments, a circular linear guide can be provided in particular in a wheel rim of the load wheel, to which linear guide a guide carriage is connected, wherein the at least one actuator and optionally the at least one damping element are arranged between the vehicle body and the guide carriage.

Alternatively, a circular linear guide could also be provided to which a guide carriage is connected, which in turn is associated with a lever element, wherein the lever element on the other hand is pivotably mounted on the vehicle body such that its pivot axle and the axis of rotation of the load wheel do not coincide, wherein the at least one actuator is configured to bring about a pivoting movement of the lever element. The embodiments of actuators and damping elements already discussed above can also be provided in these two variants.

Further features and advantages of the present invention will become clear from the following description of embodiments thereof when this is considered together with the accompanying drawings. In detail, in the drawings:

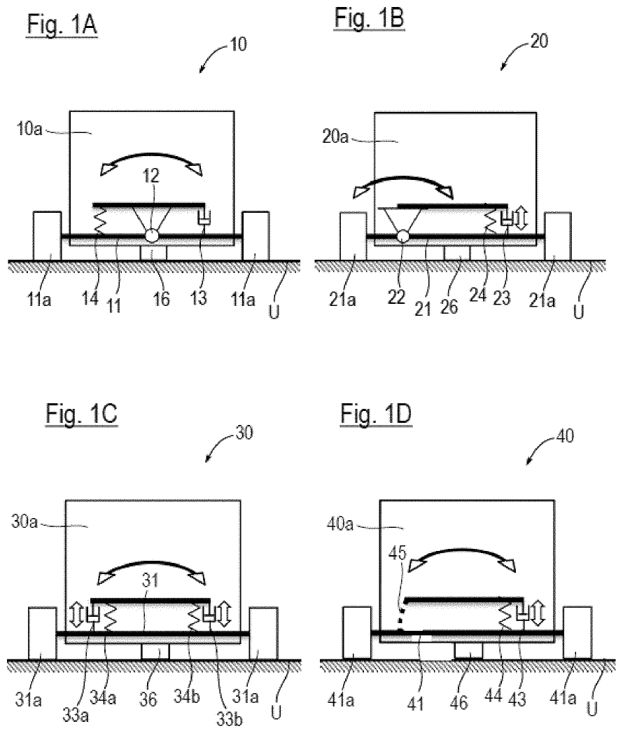

FIG. 1A-1D are schematic cross-sectional views of industrial trucks according to the invention with different variants of load axles;

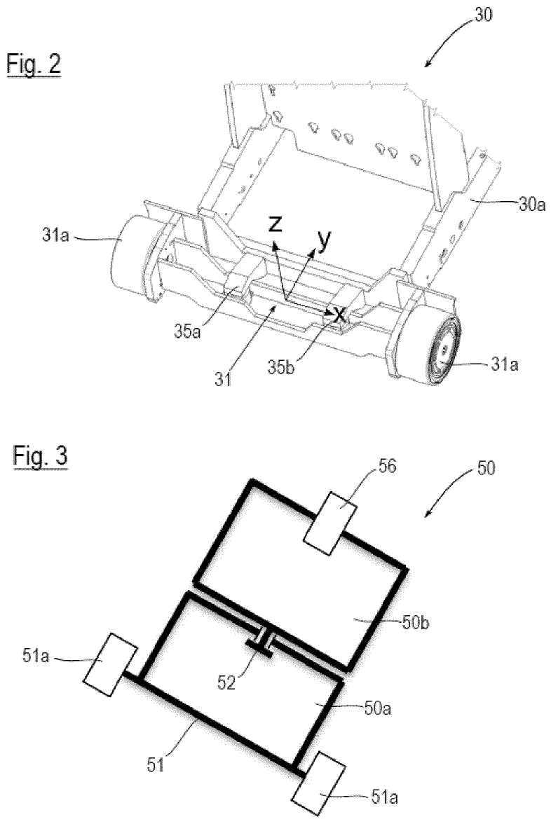

FIG. 2 is an isometric view of the variant from FIG. 1C;

FIG. 3 is a schematic view of a further variant of a load axle in an industrial truck according to the invention;

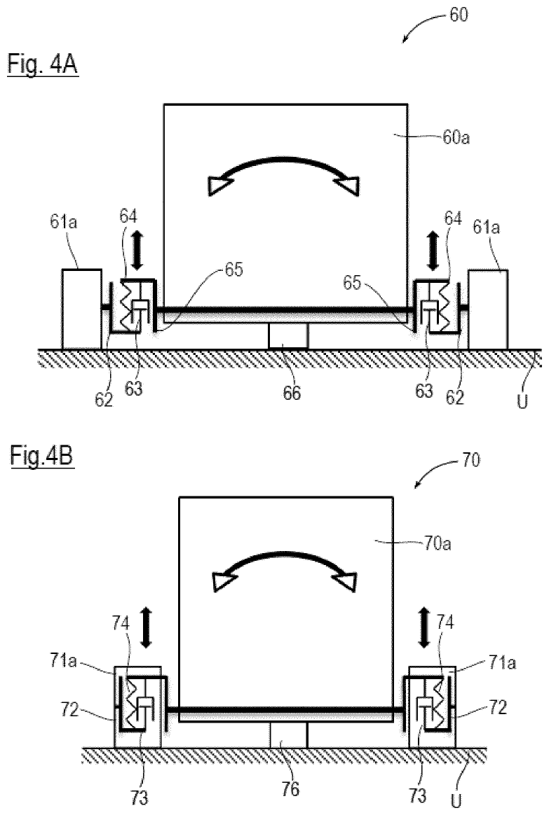

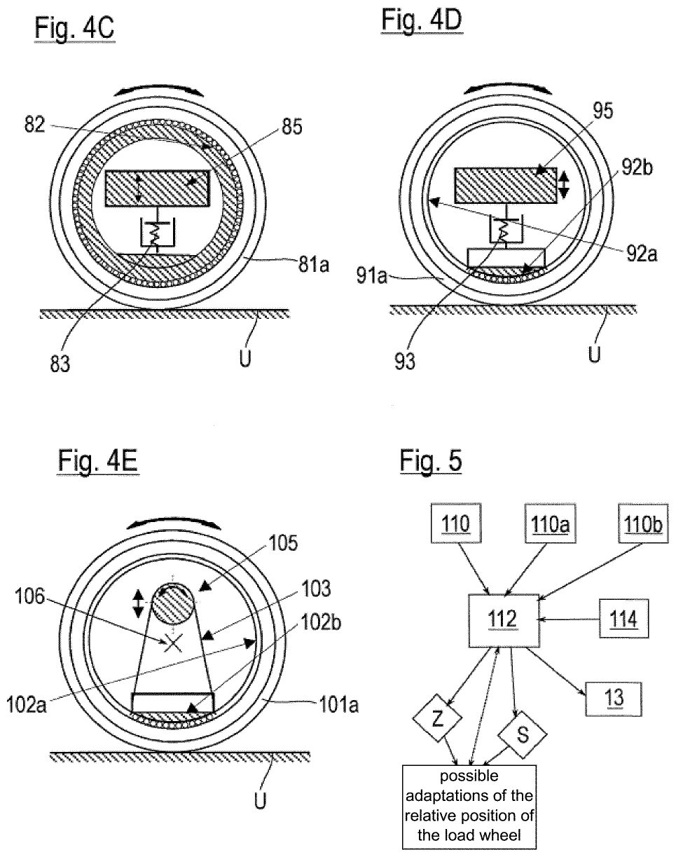

FIG. 4A-4E are schematic cross sections through further embodiments of industrial trucks according to the invention with individually suspended load wheels and embodiments of such load wheels; and

FIG. 5 is a schematic representation of the functional components of an industrial truck according to the invention.

FIG. 1A to 1D initially are schematic cross-sectional views through variants of industrial trucks according to the invention in the region of their respective load wheel axles. In the following, identical or similar components of the individual embodiments are denoted by the same reference signs, each increased by a multiple of 10, and a detailed description thereof is partially dispensed with for reasons of readability.

In this case, FIG. 1A initially shows a first embodiment of an industrial truck 10 having a vehicle body 10a and a load wheel axle 11 which carries respective load wheels 11a on both sides, with which the industrial truck 10 stands on the ground U. Outside the sectional plane, a single steered and driven wheel 16 is further indicated, which also stands on the ground U and is responsible for the drive and the steering of the vehicle 10. In other variants, the load wheel axle 11 could also be driven and the further wheel 16 could be merely steered.

The load wheel axle 11 is suspended from the vehicle body 10a of the vehicle 10 so that it can pivot about a pivot axle 12 arranged centrally in the width direction of the industrial truck 10, wherein the pivot axle 12 runs in the vehicle longitudinal direction (y), so that the pivoting movement of the load wheel axle 11 runs in the plane which is spanned by the vehicle width direction (x) and the vehicle height direction (z). The corresponding directions and axes are illustrated again below with reference to FIG. 2, the pivoting movement of the vehicle body 10a with respect to the ground U when the length of an actuator 13 changes also being indicated by a double arrow in FIG. 1A.

Laterally offset in a first direction with respect to the pivot axle 12, this variable-length actuator 13 is provided between the vehicle body 10a and the load wheel axle 11, by means of which a pivoting movement between the load wheel axle 11 and the vehicle body 10a can be effected. On the other side of the pivot axle 12 in the vehicle width direction, a damping element 14 is located opposite the actuator 13, which dampens the pivoting movements and vibrations of the load wheel axle 11 caused by the actuator 13 or occurring during the intended operation of the industrial truck 10.

Possible examples of such variable-length actuators 13 include hydraulic cylinders, lifting magnets, threaded spindles, linear motors, toothed racks, piezo elements, etc., which are controllable and whose typical stroke in the vertical direction can be approximately ±3 mm. In contrast, a mechanical spring or a hydraulic damper can be used as the damping element 14, wherein, in the case of a spring, this can be designed in such a way that a pressure is always present in the corresponding actuator 13.

A second variant of an industrial truck according to the invention is shown in FIG. 1B and denoted by the reference sign 20. In contrast to the variant from FIG. 1A, in the variant from FIG. 1B, the pivot axle 22 of the load wheel axle 21 is outside the centre of the width direction of the industrial truck 20, and the actuator 23 and the damping element 24 are both arranged on the same side of the pivot axle 22 in the vehicle width direction.

The third variant of an industrial truck according to the invention from FIG. 1C again shows an industrial truck 30 in which a pivot axle for suspending the load wheel axle 31 has been dispensed with, since this is instead suspended in the vehicle width direction, in each case spaced apart from one another by respective pairs 33a and 33b of actuators and 34a and 34b of damping elements. This embodiment variant is shown again in an isometric view in FIG. 2, in which the vehicle body 30a and the wheels 31a can be seen more clearly and the vehicle width direction is labelled with x, the vehicle longitudinal direction with y, and the vehicle height direction with z. In this case, respective pairs of one of the actuators 33a, 33b and one of the damping elements 34a, 34b are accommodated as functional units in housings 35a and 35b provided for this purpose, but it should also be noted in this context that, depending on the choice of actuators 33a and 33b in such an embodiment variant, damping elements 34a, 34b could be completely dispensed with.

FIG. 1D shows a fourth embodiment variant of an industrial truck 40 in which, instead of a pivot axle, a resilient element 45 is provided for suspending the load wheel axle 41, which element can be formed, for example, by a torsion bar. In the embodiment variant shown in FIG. 1D, this torsion bar 45 is arranged offset from the centre in the vehicle width direction, analogous to the pivot axle 22 from FIG. 1B, and the actuator 43 and the damping element 44 are located on the same side thereof.

FIG. 3 is now a schematic top view of a further embodiment variant of an industrial truck 50 according to the invention with a two-part vehicle frame which is designed in the manner of an articulated link and comprises a first frame part 50a and a second frame part 50b. In this case, the load wheel axle 51 is associated with the first frame part 50a, while the second frame part 50b can, for example, carry the lifting frame (not shown). A steered and driven further wheel 56 is also associated with the second frame part 50b. The pivotable connection of the two frame parts 50a and 50b can take place in a manner analogous to the embodiments from FIGS. 1A and 1B by means of a pivot axle 52 which is oriented in the vehicle longitudinal direction (y-direction) of the industrial truck 50.

FIGS. 4A and 4B now show two further embodiments of industrial trucks according to the invention in views similar to FIG. 1A to 1D, but the corresponding wheels of the industrial trucks are not supported by a common load wheel axle but are each suspended individually. Examples of corresponding independent wheel suspensions are then shown again in FIG. 4C to 4E.

FIG. 4A accordingly shows an embodiment of an industrial truck 60 having a vehicle body 60a, on which two load wheels 61a are individually suspended in an identical manner opposite one another in the vehicle width direction. The load wheels 61a are in this case, as indicated by respective double arrows, relatively displaceable in the height direction with respect to the vehicle body 60a, whereby the pivoting movement of the vehicle body 60a with respect to the ground U, also indicated by a double arrow, can be triggered. For this purpose, the two load wheels 61a are each supported on a flange plate 62 which is fastened via an actuator 63 and a damping element 64 to a corresponding counterpart 65 associated with the vehicle body 60a. The above-mentioned inclining of the vehicle body 60a relative to the ground U can thus be achieved by asynchronous control of the two actuators 63.

In the embodiment variant of an industrial truck 70 from FIG. 4B, in contrast to the variant from FIG. 4A, the actuators 73 and damping elements 74 are each included in a view along the height direction (z-direction) within the contour of the wheel bodies 71a, in that the flange plates 72 close the wheel bodies in each case in the width direction of the vehicle 70 to the outside. As a result, with the same function compared to the embodiment from FIG. 4A, significant savings are made on installation space.

Three variants of the independent wheel suspension discussed in connection with FIG. 4B are now shown in FIG. 4C to 4E. Here, in FIG. 4C, a load wheel 81a is rotatably supported by means of a wheel bearing 82, which wheel bearing 82 is associated with the vehicle body (not shown) by means of an actuator 83 and optionally a damping element (not shown) at a fixed point 85 on a counter element.

In contrast to this, the wheel bearing is dispensed with in the embodiment from FIG. 4D and only a guide carriage 92b engaging on a circular linear guide 92a is used for the rotatable support of the load wheel 91a which, however, in an analogous manner via an actuator 93 and optionally a damping element is associated with the vehicle frame (not shown) at a fixed point 95.

Finally, FIG. 4E shows a further variant of an independent wheel suspension, in which a load wheel 101a is also rotatably supported by means of a linear guide 102a, but this is associated with a lever element 103, which in turn is pivotably mounted at a fixed point 105 on the vehicle frame (not shown), the fixed point 105 being offset from the centre of rotation 106 of the load wheel 101a. Since an actuator (not shown) is now configured to cause a pivoting movement of the lever element 103, a relative displacement between the load wheel 101a and the vehicle body (not shown) can be achieved in the height direction with a further contribution in the longitudinal direction of the vehicle by means of the offset of the fixed point 106 from the centre of rotation 105.

Finally, FIG. 5 now shows a schematic functional diagram of functional components of an industrial truck according to the invention, as can be used with each of the embodiments of load wheel arrangements just discussed. In particular, FIG. 5 shows one of the actuators discussed, for example the actuator 13 from FIG. 1A, the actuator 23 from FIG. 1B, etc., wherein, for reasons of readability, only the actuator 13 will be mentioned in the following.

As mentioned, this actuator 13 is configured to adapt a relative position of a load wheel with respect to the vehicle body in an industrial truck according to the invention. Furthermore, the arrangement from FIG. 5 comprises a detection unit 110, which is configured to detect a current operating parameter of the industrial truck and to output corresponding data. These data are passed on to a control unit 112 having an associated memory unit 114, which control unit is operationally coupled to the actuator 13. The control unit 112 and also the memory unit 114 can be of any known type and, for example, can be operationally coupled to a central controller of the corresponding industrial truck or integrated therein.

Furthermore, at least one further detection unit 110a can also be provided in the vehicle, which detects at least one property of the surroundings of the vehicle and outputs corresponding data to the control unit 112. Alternatively or additionally, a receiving device 110b can be provided in the vehicle, which is configured to receive data from an external means, which data represent information about the position or the surroundings of the industrial truck.

In this case, the control unit 112 is configured to define a target state S of the industrial truck, to receive data from the detection unit 110, to determine an actual state Z of the industrial truck based on the detected operating parameters of the industrial truck, to calculate the effects of possible adjustments of the relative position of the load wheel 11a with respect to the vehicle body 10a on the actual state Z of the industrial truck, and then to instruct the actuator 13 in such a way that an approximation of the actual state Z of the industrial truck to the target state S is brought about by adjusting the relative position of the load wheel 11a with respect to the vehicle body 10a.

1. An industrial truck, comprising:
a vehicle body;
a lifting frame which extends substantially vertically from the vehicle body;
at least one load wheel which stands on a ground;
at least one further wheel, which also stands on the ground and is configured to drive the industrial truck in a steered manner to a movement on the ground;
at least one actuator associated with the at least one load wheel, which is configured and arranged to adjust a relative position of the load wheel with respect to the vehicle body;
at least one detection unit, which is configured to detect a current operating parameter of the industrial truck and to output corresponding data; and
a control unit having an associated memory unit, wherein the control unit is operationally coupled to the at least one actuator and the at least one detection unit, wherein the control unit is configured to:
define a target state of the industrial truck;
receive data from the detection unit;
determine an actual state of the industrial truck based on the detected the operating parameter of the industrial truck;
calculate effects of possible adjustments of the relative position of the load wheel with respect to the vehicle body on the actual state of the industrial truck; and
instruct the at least one actuator to adjust the relative position of the load wheel with respect to the vehicle body to approximate the actual state of the industrial truck to the target state.

2. The industrial truck of claim 1, wherein the at least one detection unit is configured to detect at least one of:
an inclination of the vehicle body relative to one or more of the ground or a horizontal; and
one or more of:
an acceleration,
a speed,
an inclination of at least one component of the industrial truck,
a load carried by the industrial truck with respect to the ground, or
at least one other component of the industrial truck.

3. The industrial truck of claim 1, further comprising at least one additional detection unit configured to detect at least one property of the surroundings of the industrial truck and to output corresponding data to the control unit.

4. The industrial truck of claim 1, wherein the at least one detection unit is associated with the at least one load wheel.

5. The industrial truck of claim 1, wherein the at least one detection unit is associated with one or more of the vehicle body, the lifting frame, or a component of the industrial truck connected to the vehicle body or the lifting frame.

6. The industrial truck of claim 1, wherein at least one spatial characteristic diagram is stored in the memory unit of the control unit wherein the control unit is configured to determine an upcoming change in the actual state of the industrial truck based on current movement parameters of the industrial truck and the at least one spatial characteristic diagram.

7. The industrial truck of claim 1, further comprising at least one receiving device configured to receive data from an external means, wherein the data represent information about the position or the surroundings of the industrial truck.

8. The industrial truck of claim 1, further comprising at least one load wheel axle configured to carry two load wheels lying opposite one another.

9. The industrial truck of claim 8, wherein the at least one load wheel axle is suspended on the vehicle body such that the at least one load wheel axle can pivot about a pivot axle running horizontally perpendicular to the load wheel axle or by means of a resilient element and wherein the at least one actuator is configured to cause the load wheel axle to pivot.

10. The industrial truck of claim 8, further comprising at least two actuators spaced apart from one another between the at least one load wheel axle and the vehicle body.

11. The industrial truck of claim 9, further comprising a guide unit for mounting the load wheel axle in the plane, wherein the guide unit is spanned by a vertical direction and an extension direction of the load wheel axle.

12. The industrial truck of claim 8, wherein the at least one load wheel is associated with a frame element pivotably articulated on the vehicle body.

13. The industrial truck of claim 8, wherein the at least one load wheel is arranged individually on the vehicle frame in a linearly displaceable manner in a horizontal direction by at least one actuator.

14. The industrial truck of claim 13, wherein the at least one actuator is arranged at least in portions within the contour of the load wheel.

15. The industrial truck of claim 14, further comprising a circular linear guide in a wheel rim of the load wheel, wherein a guide carriage is connected to the circular linear guide, wherein the at least one actuator is arranged between the vehicle body and the guide carriage.

16. The industrial truck of claim 14, further comprising a circular linear guide in a wheel rim of the load wheel, wherein a guide carriage is connected to the circular linear guide, wherein the guide carriage is associated with a lever element, wherein the lever element is pivotably mounted on the vehicle body such that its pivot axle and the axis of rotation of the load wheel do not coincide, wherein the at least one actuator is configured to bring about a pivoting movement of the lever element.

17. The industrial truck of claim 10, further comprising at least one of a damping element and an element for load compensation between the at least one load wheel axle and the vehicle body.

18. The industrial truck of claim 13, further comprising a damping element for one or more of (a) dampening the linear movement or (b) load compensation.

19. The industrial truck of claim 14, wherein the at least one damping element is arranged at least in portions within the contour of the load wheel.

20. The industrial truck of claim 15, wherein the at least one damping element are arranged between the vehicle body and the guide carriage.
